(19) United States
(12) Patent Application Publication
(10) Pub. No.: US 2014/0290346 A1
(43) Pub. Date: Oct. 2, 2014

(54) MEASUREMENT INSTRUMENT HAVING TOUCHSCREEN USER INTERFACE AND METHOD FOR MEASURING VISCOSITY

(71) Applicants: James A. Salomon, Providence, RI (US); Alex H. Mak, Canton, MA (US); Robert P. Bishop, Pembroke, MA (US); Charles J. Falzarano, Lakeville, MA (US); Teresa L. McKim, Abington, MA (US); Jason P. Hartshorn, East Bridgewater, MA (US); David A. DiCorpo, Bridgewater, MA (US)

(72) Inventors: James A. Salomon, Providence, RI (US); Alex H. Mak, Canton, MA (US); Robert P. Bishop, Pembroke, MA (US); Charles J. Falzarano, Lakeville, MA (US); Teresa L. McKim, Abington, MA (US); Jason P. Hartshorn, East Bridgewater, MA (US); David A. DiCorpo, Bridgewater, MA (US)

(21) Appl. No.: 14/213,594

(22) Filed: Mar. 14, 2014

Related U.S. Application Data
(60) Provisional application No. 61/791,305, filed on Mar. 15, 2013.

(51) Int. Cl. G01N 11/14

(52) U.S. Cl. CPC G01N 11/14
USPC 73/54.32

(57) ABSTRACT

The present disclosure provides a viscometer or a rheometer including a touch screen interface. The touch screen interface enables a wider variety of user interface options and functions that would otherwise be cumbersome to implement. These options and functions include a wide variety of settings, security features, and the ability to manipulate test definitions and test data.

### RELATED APPLICATION

This application claims the benefit of priority to U.S. Provisional Application No. 61/791,305 filed on Mar. 15, 2013, the entire contents of which are incorporated herein by reference for all purposes.

### BACKGROUND

The present disclosure relates to a measurement instrument (e.g., viscometer or rheometer) and a method for controlling the measurement instrument. More particularly, the present disclosure relates to a measurement instrument (e.g., viscometer or rheometer) having a touch screen user interface and a method for controlling use of the measurement instrument and controlling the acquisition and management of collected test data (e.g., viscosity).

Conventional viscometer or rheometer instruments do not include a graphical user interface. Measurement results cannot be shown in the display of the conventional viscometers or rheometers in a real-time setting. Moreover, conventional viscometers or rheometers do not include a touch screen. Accordingly, user interactions with the conventional viscometer or rheometer are very limited.

### SUMMARY

The present disclosure provides an instrument of the above class with touch screen interface, and data measurement and management means.

In one aspect, the touch screen interface of the measurement instrument of the present disclosure provides a flexible interface, for both entering information and viewing test results in selected formats, including graphical and/or comparisons.

In one aspect, the enclosure of the measurement instrument of the present disclosure includes a bubble level at a lower front portion of the viscometer proximate a lower edge of the touch screen, thereby rendering the bubble level more visible.

In one aspect, the present disclosure provides an apparatus for measuring viscosity of a liquid. The apparatus comprises a console unit having a touch panel at a front portion thereof, the touch screen displaying a graphical user interface configured to receive input and display output for a viscosity measurement; a driving member coupled to the console unit and configured to rotate a spindle in the liquid; a deflection member coupled to the console unit and configured to measure viscous drag of the fluid against the rotating spindle; and a base stand supporting the console unit. The console unit further comprises a leveling indicator disposed at a front portion thereof adjacent a lower edge of the touch screen.

In one embodiment, the base stand comprises leveling feet to control leveling of the console unit in view of the leveling indicator. In one embodiment, the touch screen is slanted at an angle relative to a vertical direction. The angle may be about 15 degrees.

In one embodiment, the apparatus further comprises a height adjustment mechanism coupled between the console unit and the base stand.

In one embodiment, the graphical user interface, comprises a graphical representation of viscosity data measured real time from the deflection member.

In one embodiment, the graphical user interface comprises an alphanumeric representation of one or more test result data of the viscosity measurement. Said one or more test result data comprises one or more of a viscosity value, a shear stress value, a temperature value, a torque value, a shear rate value, and a rotation speed value.

In one embodiment, the graphical user interface comprises an alphanumeric representation of one or more test parameters of the viscosity measurement. Said one or more test parameters comprises one or more of a spindle type, a temperature setting, a data collection method, a rotational speed setting, and an end condition.

In one embodiment, the graphical user interface comprises a status bar at a top portion of the touch screen, the status bar displaying one or more of a USB icon, a printer icon, a computer icon, a thermal bath icon, a temperature icon, and date/time information.

In one embodiment, the graphical user interface comprises a command bar at a bottom portion of the touch screen, the command bar displaying one or more of a clear button, a save button, and a run button.

In another aspect, the present disclosure provides a method for measuring viscosity of a liquid. The method comprises configuring viscosity test parameters through a graphical user interface displayed on a touch screen of a measuring instrument; providing the viscosity test parameters to a driving member of the measuring instrument to drive a spindle in a sample liquid in accordance with the viscosity test parameters; measuring viscous drag of the sample fluid against the rotating spindle; and displaying on the touch screen a graphical representation of measurement results associated with the viscous drag.

In one embodiment, the method further comprises loading the viscosity test parameters from a data file saved in a memory of the measuring instrument. In another embodiment, the method further comprises loading the viscosity test parameters from a data file saved in a memory device coupled to a communication port of the measuring instrument.

In one embodiment, the method further comprises, prior to configuring the test parameters, entering a user identification through the graphical user interface to restrict access of the measurement instrument.

In one embodiment, the method further comprises auto-zeroing the measurement instrument to set zero readings of the measurement instrument.

In one embodiment, the method further comprises leveling the measurement instrument by referencing a leveling indicator disposed adjacent a lower edge of the touch screen.

In one embodiment, the method further comprises displaying on the touch screen an average value of the measurement results.

In still another aspect, the present disclosure provides a computer program product stored in a memory of a measurement instrument, the computer program product, when executed by a processor of the measurement instrument, causing the measurement instrument to perform a method for measuring viscosity of a liquid, the method comprising: configuring viscosity test parameters through a graphical user interface displayed on a touch screen of the measuring instrument; providing the viscosity test parameters to a driving member of the measuring instrument to drive a spindle in a sample liquid in accordance with the viscosity test parameters; measuring viscous drag of the sample fluid against the rotating spindle; and displaying on the touch screen a graphical representation of measurement results associated with the viscous drag.

For better understanding of the present disclosure, reference is made herein to the accompanying drawings and detailed description.

### BRIEF DESCRIPTION OF THE DRAWINGS

FIG. 1 illustrates a perspective view of a measurement instrument in accordance with an embodiment of the present disclosure.

FIG. 2 illustrates a side view of a measurement instrument in accordance with an embodiment of the present disclosure.

FIG. 3 illustrates another side view of a measurement instrument showing the internal portion of a measurement instrument, in accordance with an embodiment of the present disclosure.

FIG. 4 illustrates a rear view of a measurement instrument in accordance with an embodiment of the present disclosure.

FIG. 5 illustrates a block diagram of a measurement instrument in accordance with an embodiment of the present disclosure.

FIG. 6 illustrates a data structure generated by a measurement instrument in accordance with an embodiment of the present disclosure.

FIG. 7 illustrates a graphical user interface of a measurement instrument in accordance with an embodiment of the present disclosure.

FIG. 8 illustrates another graphical user interface of a measurement instrument in accordance with an embodiment of the present disclosure.

FIGS. 9-33 illustrate additional graphical user interfaces for a measurement instrument in accordance with an embodiment of the present disclosure.

### DETAILED DESCRIPTION

The present disclosure provides a measurement instrument with enhanced overall shape, including the touch screen and the bubble level design and location. In some aspects, the use of a touch screen mandates design decisions about navigation, file structures, how tests are described and set up, and how test data is displayed and compared. This is not a simple replication of existing functions to the new format, but rather unique and valuable solutions to many design problems. According to some aspects, the measure instrument of the present disclosure includes the following features:
a. Test data includes all of the test settings, so that the test can be re-run, and for traceability;
b. Data is displayed during a test, and captured afterword, with many options for sampling data points, and averaging;
c. During a test, there are many options for the display of data, time of test, etc, that can be changed dynamically;
d. Tests are set up with varying degrees of complexity, from simply running a torque measurement, to multi-step tests via the same set up screens; and
e. The instrument enables comparison of test data in a tabular format.

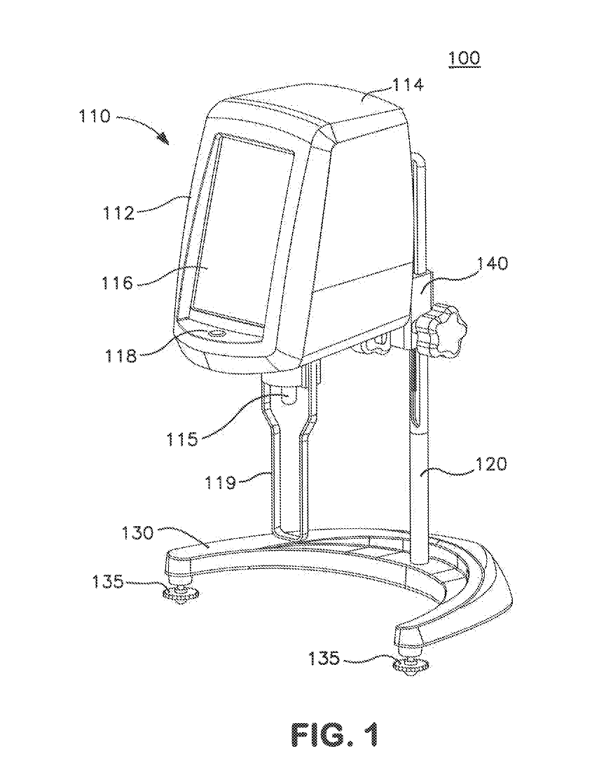

Referring to FIGS. 1-4, various views of a measurement instrument 100 according to the present disclosure are illustrated.

Referring to FIG. 1, measurement instrument 100 comprises a console unit 110, a vertical rod 120, a base stand 130, and a height adjustment mechanism 140. Console unit 110 comprises a housing having a front portion 112 and a rear portion 114, a display unit 116 disposed in front portion 112 of the housing, a leveling indicator 118, a spindle holder 115, and a protector 119 (optional). Spindle holder 115 is disposed at a bottom portion of console unit 110. In one embodiment, display unit 116 is a touch screen and leveling indicator 118 is a bubble level vial.

Console unit 110 may be securely engaged with vertical rod 120 through height adjustment mechanism 140. Base stand 130 may have a crescent shape leaving space below spindle holder 115 such that a fluid sample can be placed under console unit 110 for testing. Console unit 110 may be leveled using leveling feet 135 formed at tip portions of base stand 130.

Display unit 116 may be disposed in front portion 112 to be slightly slanted at an angle of about 15 degrees with respect to a vertical direction. The slanted display unit 116 may ensure that, when a user touches display unit 116 for controlling console 110, the force of the user's touches would not elevate leveling feet 135 from a table top. This would prevent the user touches from adversely affecting the accuracy of measurements.

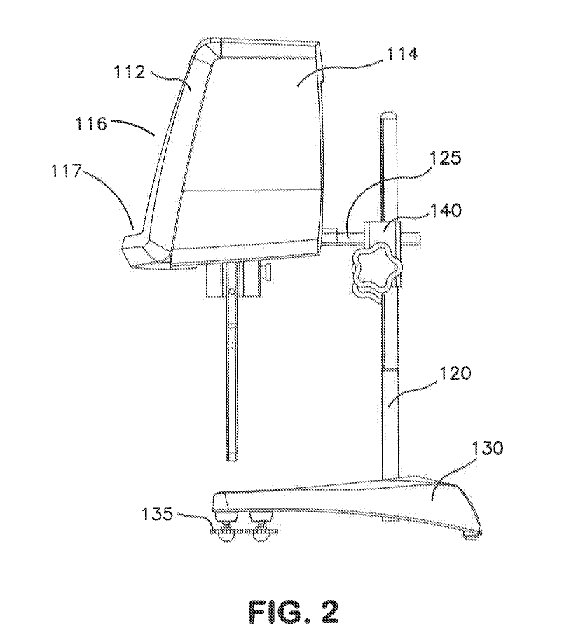

Referring to FIG. 2, leveling indicator 118 is disposed at a lower platform 117 of front portion 112 adjacent a bottom edge of display unit 116. This particular position of leveling indicator 118 allows a user to easily monitor the leveling of console unit 110 during the operation of measurement instrument 100.

Console unit 110 may be securely fastened to a horizontal rod 125, which may be securely engaged with vertical rod 120 through height adjustment mechanism 140. Vertical rod 120 may be substantially perpendicular with horizontal rod 125. Further, vertical rod 120 may be securely fastened to a central portion of base stand 130 haying a crescent shape.

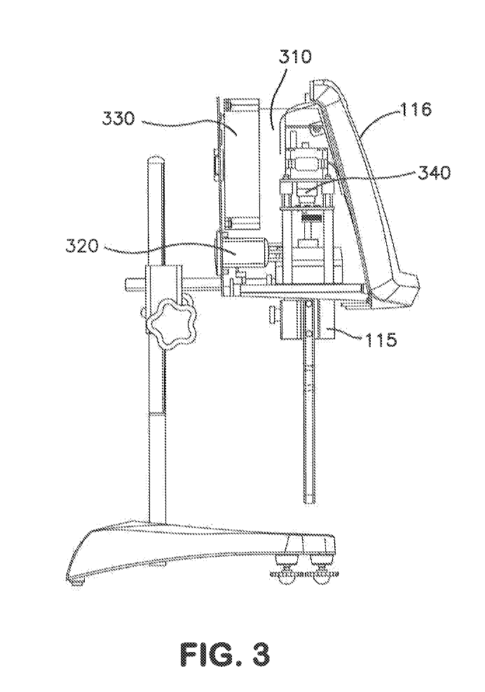

Referring to FIG. 3, internal components of console unit 110 are illustrated. As shown, console unit 110 further comprises a main circuit board 310, a power supply 320 coupled to main circuit board 310, a communications interface module 330 coupled to main circuit board 310, and a motor module 340 coupled to main circuit board 310. In one embodiment, circuit board 310 may be disposed vertically at a side of console unit 110. Motor module 340 is mechanically coupled to spindle holder 115 for rotating a spindle (not shown) attached thereto. In one embodiment, motor module 340 includes a rotary transducer to measure the torque exerted on the spindle due to fluid viscosity.

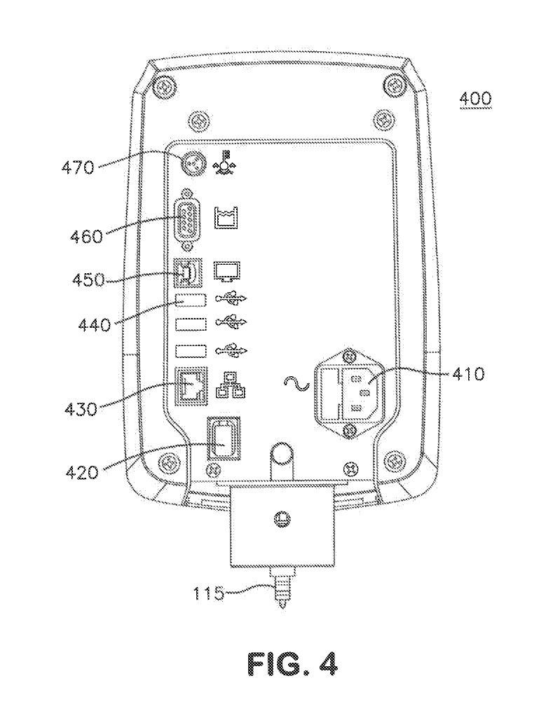

Referring to FIG. 4, a rear portion 400 of console unit 110 is illustrated. As shown, rear portion 400 of console unit 110 comprises a power socket 410, a power switch 420, and a plurality of communication interfaces, including a network interface 430, universal serial bus interfaces 440, a computer interface 450, a bath interface 460, and a temperature interface 470. The communication interfaces 430-470 are coupled to communications interface module 330. Power socket 410 and power switch 420 are coupled to power supply 310. Note that the communication interfaces are shown and described merely for illustrative purposes. In various embodiments, more or less of the communication interfaces may be included on console unit 110 depending on design preferences.

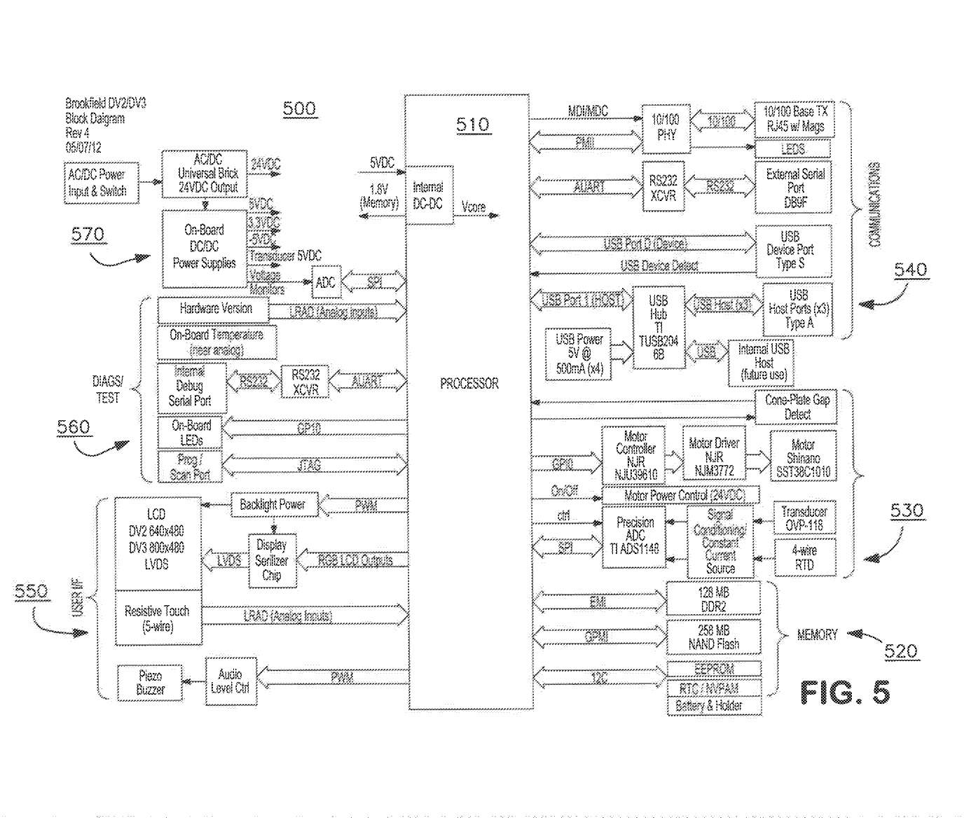

FIG. 5 illustrates a block diagram of a measurement instrument 500 in accordance with an embodiment of the present disclosure. As shown, measurement instrument 500 may comprise a processor 510, memory 520 coupled to processor 510, sensors 530 coupled to processor 510, communications interface 540 coupled to processor 510, user interface 550 coupled to processor 510, diagnostic and testing module 560 coupled to processor 510, and a power supply 570 coupled to processor 510.

In one embodiment, memory 520 may be disposed on main circuit board 310 inside of the housing of console unit 110. With memory 520 (or any internal data storage), one can store many data files and test parameters within the instrument 100 itself. Further, the internal data storage may be used to store an operating system so as to implement the graphical user interface on the touch screen and to set up a file system.

FIG. 6 illustrates a data structure 600 generated by a measurement instrument 500 in accordance with an embodiment of the present disclosure. As shown, data structure 600 includes a test file portion 610 and a data file portion 620. Test file portion 610 of data structure 600 defines various testing parameters including, for example, test date/time information (e.g., {Date/Time})), tester/user information (e.g., {Tester}), console unit information (e.g., {SerialNumber}, {Model}, {FWV}), spindle information (e.g., {Sp#}, {Spindle}, {Spindle Multiplier Constant (SMC)}, {Shear Rate Constant (SRC)}), and number of steps information (e.g., {#Steps=n}), In each measurement step, test file portion 610 of data structure 600 may further define spindle speed information (e.g., {#1 Speed}), temperature setpoint information (e.g., {TemptrStpt}), data collection method (e.g., {IntTime}, {AvgTime}), end condition (e.g., {EndType}, {EndVal}), and other measurement information (e.g., {Density}, {QCType}, {QCLow}, {QCHigh}). Data file portion 620 of data structure 600 records testing results of, for example, measurement step (e.g., {#1 Step}), measurement time (e.g., {Time}), measured torque (e.g., {Torque}), and measured sample temperature (e.g., {Temptr}).

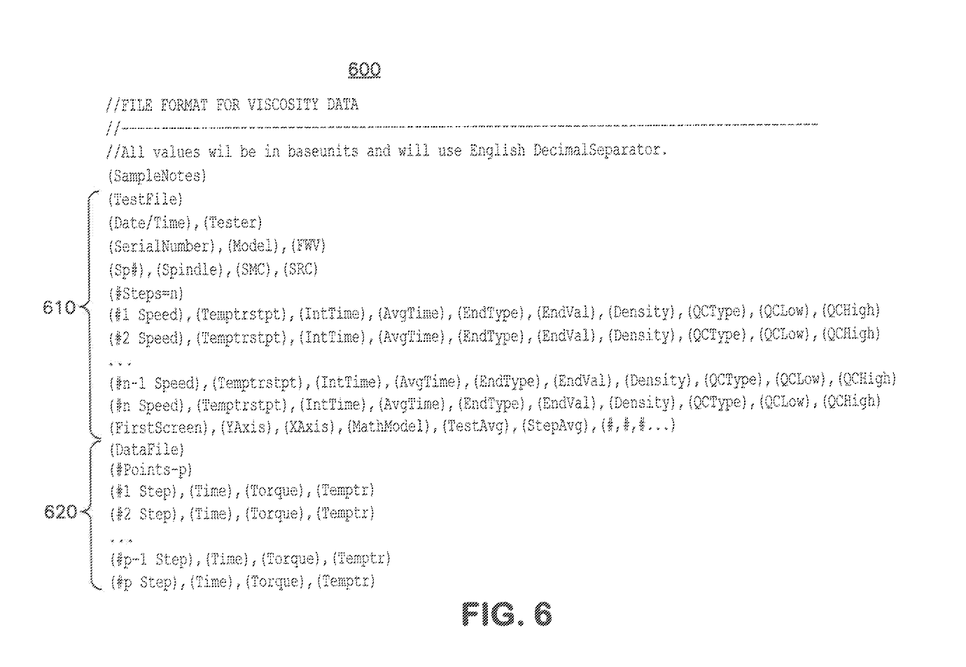

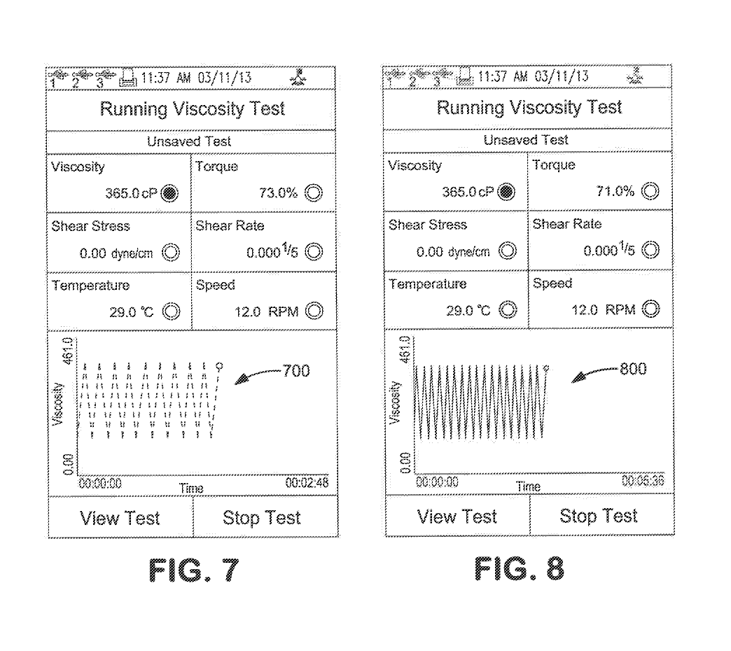

FIGS. 7 and 8 illustrate graphical user interfaces of a measurement instrument in accordance with an embodiment of the present disclosure. As shown, measurement results (e.g., viscosity) may be shown on display unit 116 in real-time while measurements are taken place, FIG. 7 shows a time sequence of viscosity data 700 after testing a sample for about 2 minutes. FIG. 8 illustrate a time sequence of viscosity data 800 after testing a sample for about 3 minutes.

Measurement data may be averaged and displayed in various different manners. For example, measurement data may be averaged post testing with test average. That is, one point may be calculated from the collected data of several steps within a multi step program. Such data includes average and standard deviation for viscosity, shear stress, torque, and temperature.

In addition, measurement data may be averaged post testing with step average. That is, one point may be calculated for each step within a multi step program, using all of the data collected in that step. Such data includes average and standard deviation for viscosity, shear stress, torque, and temperature.

Further, measurement data may be averaged in real time, i.e., live average. That is, each collected data point is a time based average of measured values. Such data averaged includes viscosity, shear stress, torque, and temperature.

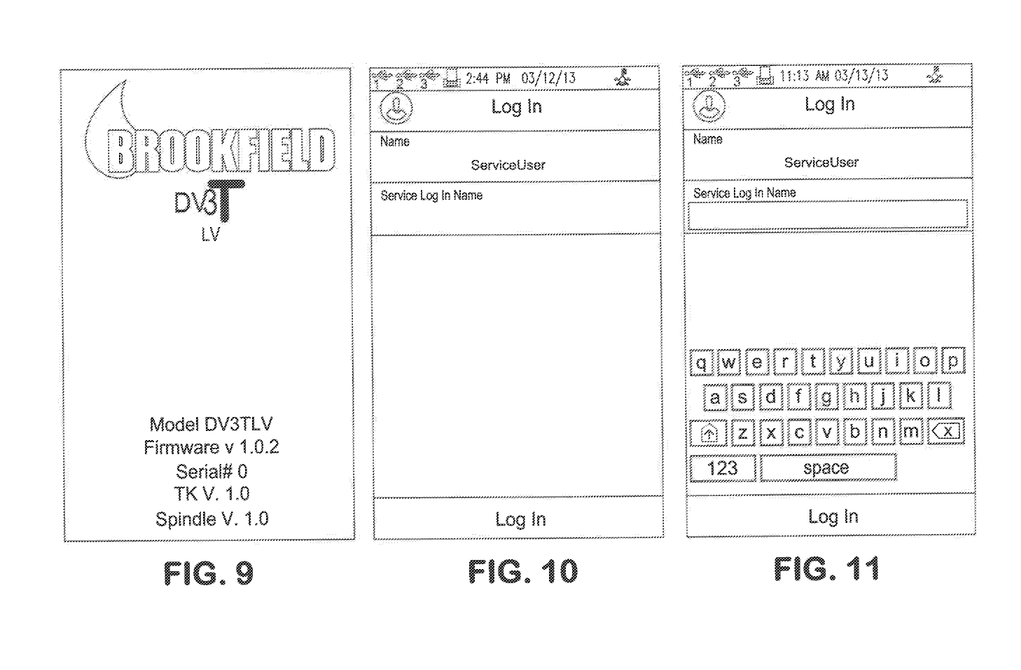

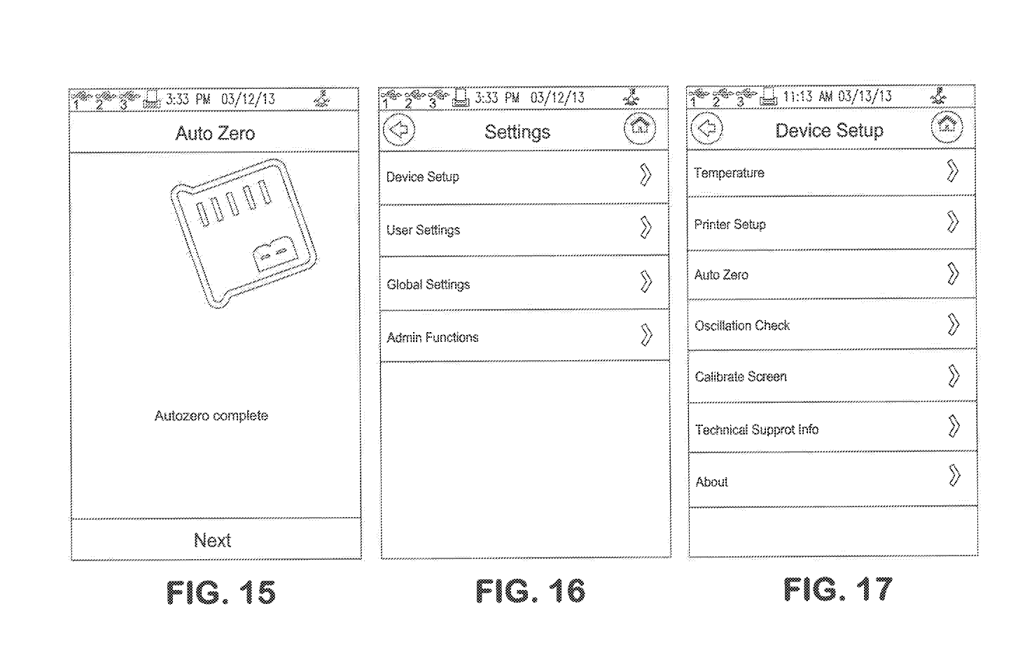

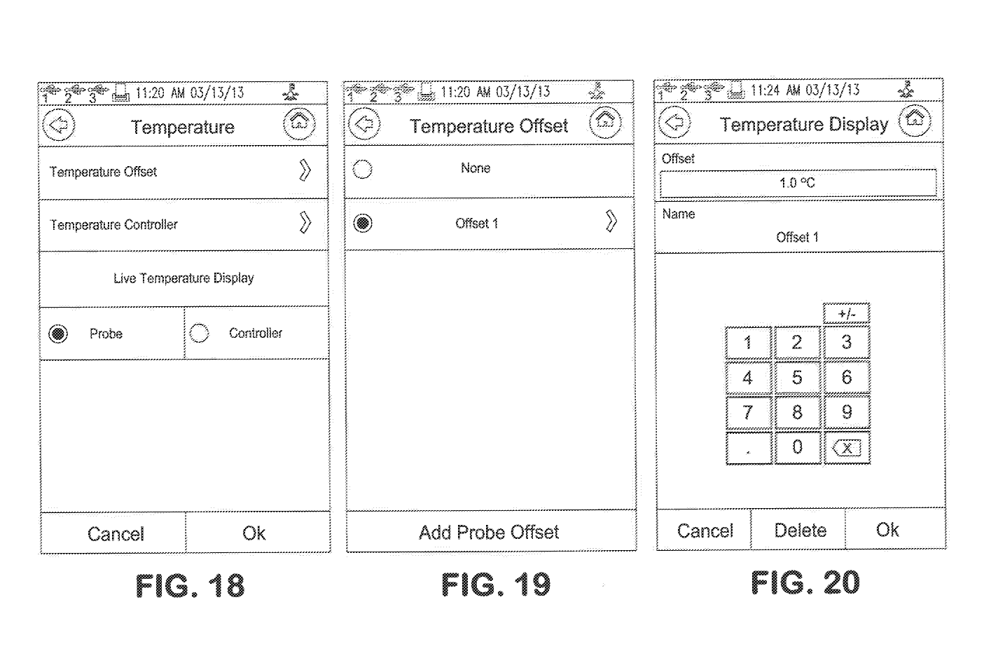

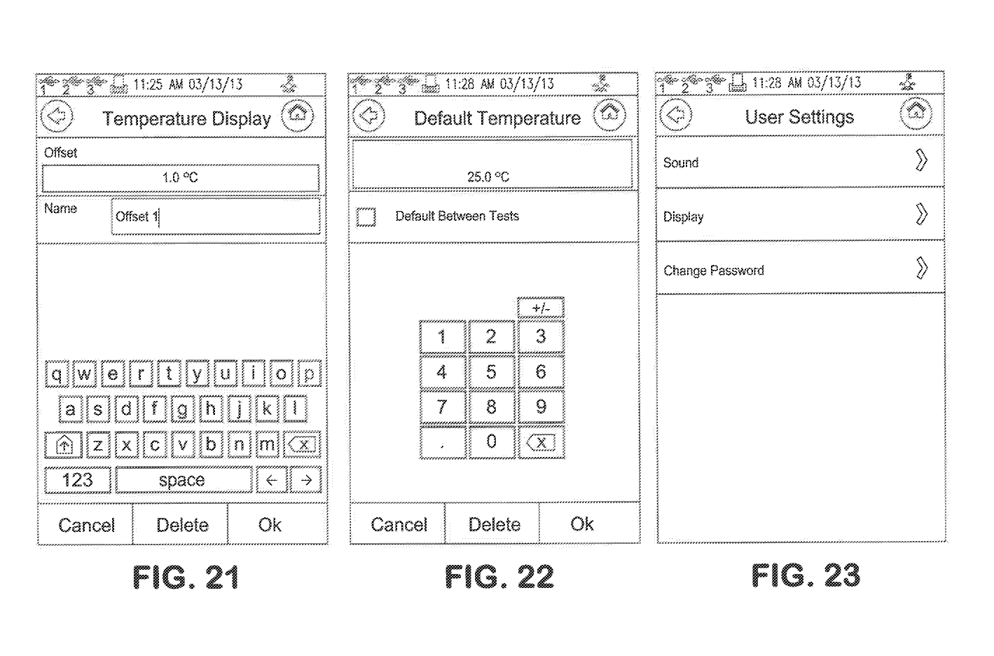

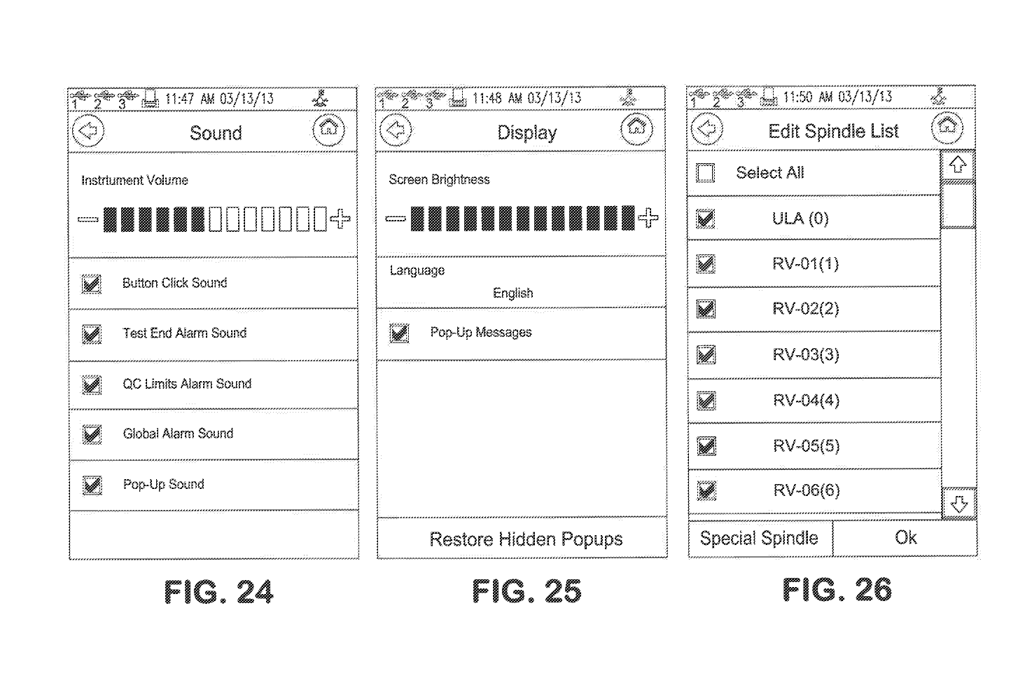

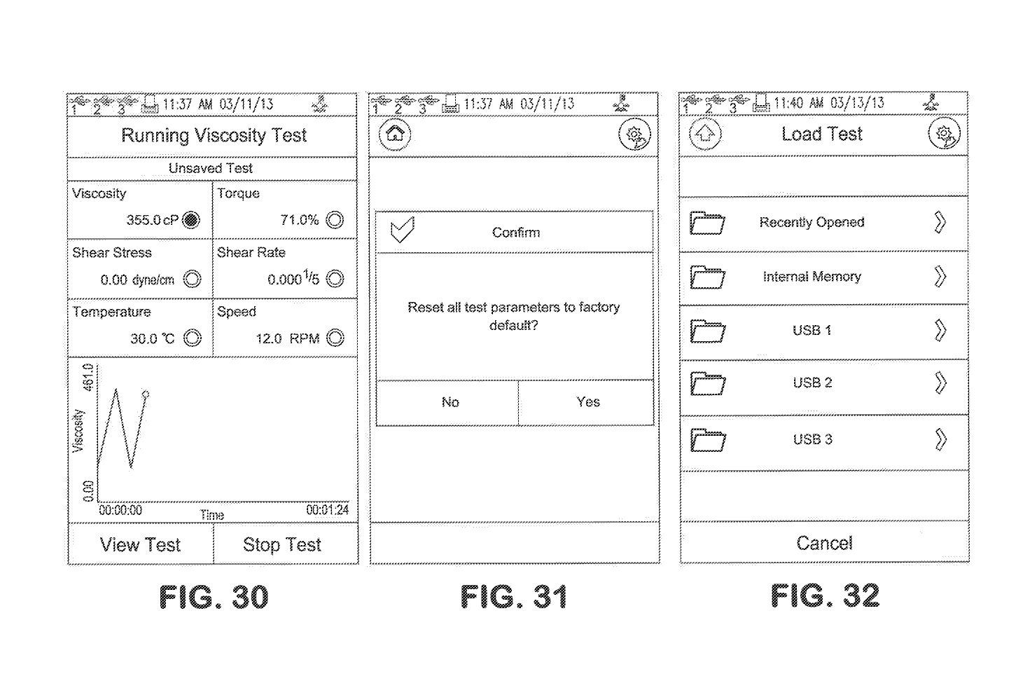

FIGS. 9-32 illustrate additional graphical user interfaces for a measurement instrument in accordance with an embodiment of the present disclosure.

In one example, a measurement instrument of the present disclosure incorporates a full-color graphical touch screen display with a user interface. The measurement instrument measures viscosity at given shear rates. Viscosity is a measure of a fluid's resistance to flow.

The principal of operation is to drive a spindle (which is immersed in the test fluid) through a calibrated spring. The viscous drag of the fluid against the spindle is measured by the spring deflection. Spring deflection is measured with a rotary transducer. The measurement range of the measurement instrument (in centipoise or milli-Pascal seconds) is determined b the rotational speed of the spindle, the size and shape of the spindle, the container the spindle is rotating in, and the full scale torque of the calibrated spring. The higher the torque calibration, the higher the measurement range. All units of measurement are displayed according to either the CGS system or the SI system.

When the power is turned on, the measurement instrument of the present disclosure goes through a Power Up sequence, in which the measurement instrument issues a beep, presents a blue screen, and shows an About screen for about 5 seconds. The About screen is shown in FIG. 9 and includes several critical parameters about the measurement instrument, including viscometer torque (LV, RV, HA, MB, or other), firmware version number, model number (LVDV2 for example) and the serial number. The About screen can also be accessed through the Settings Menu shown in FIG. 17. The measurement instrument automatically transitions from the About Screen (FIG. 9) to the AutoZero screen (FIGS. 13-15).

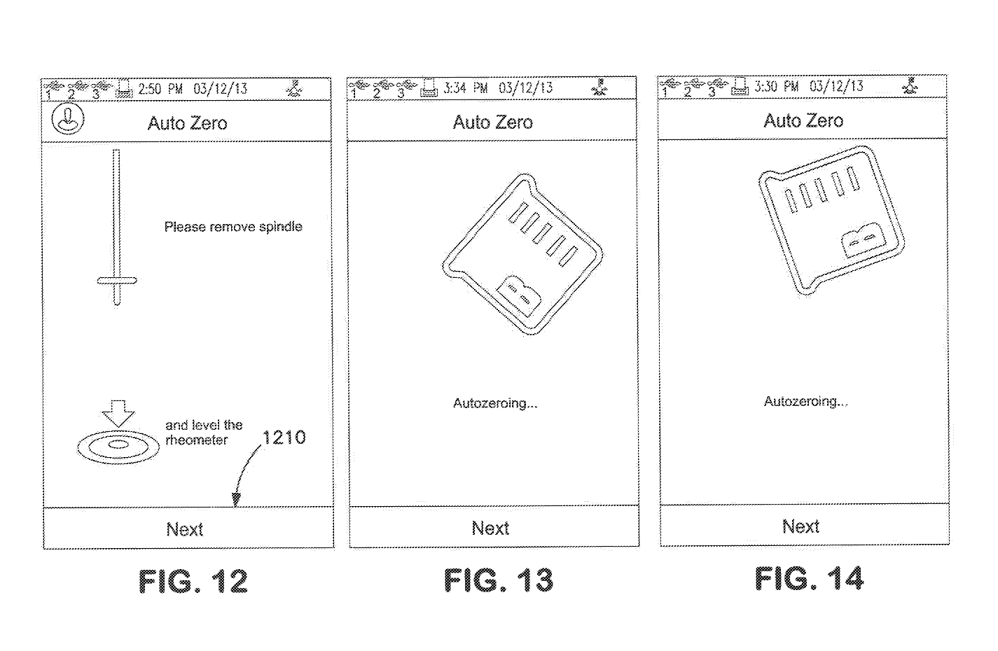

The measurement instrument must perform an AutoZero prior to making measurements. This process sets the zero reading for the measurement system. The AutoZero is performed every time the measurement instrument is turned on. Additionally, one may force an AutoZero at any time through the Settings Menu (FIG. 17). The AutoZero screen (FIG. 12) is presented automatically after the About Screen, during the power up sequence.

The operator must ensure that the measurement instrument is level and remove any attached spindle or coupling. When the Next button 1210 (FIG. 12) is pressed, the measurement instrument operates for approximately 3 seconds. After the AutoZero is complete and the operator presses the Next button 1210, the measurement instrument transitions to the Configure Test screen (FIGS. 28 and 29). If the AutoZero is performed from the Settings Menu (FIGS. 16 and 17), then the measurement instrument returns to the Settings Menu. The measurement instrument should not be touched during the AutoZero process to ensure the best zero value.

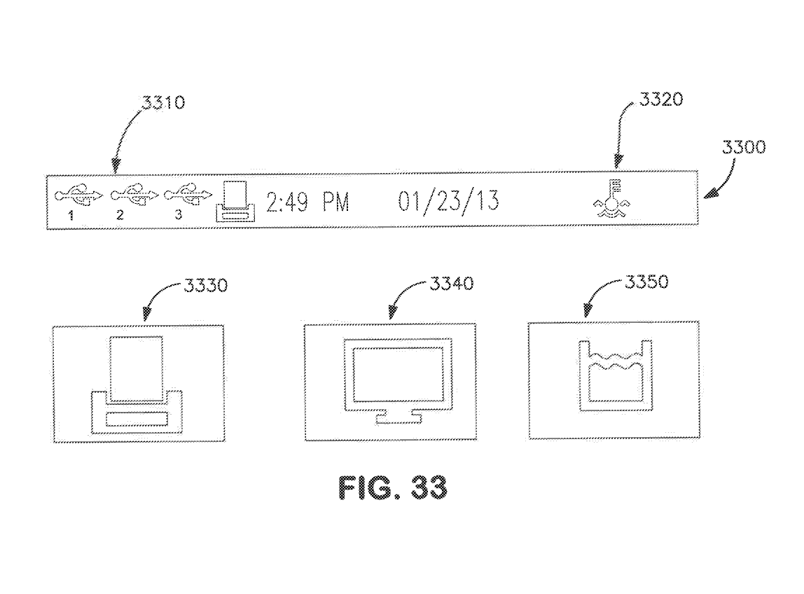

Referring to FIGS. 7-32, the measurement instrument of the present disclosure can display a status bar at the top of the screen at all times. FIG. 33 shows an enlarged view of the status bar. As shown in FIG. 33, a status bar 3300 can indicate time of day, date, and connection status for a variety of connection devices. The status icons 3300 at least include USB icons 3310 and temperature icon 3320. The measurement instrument can store data and test results to a USB storage device (such as a memory stick) through one of three USB ports of the measurement instrument, and USB icons 3310 indicates whether any of the USB ports are connected with an external device. In addition, the measurement instrument can measure temperature when a temperature probe is connected to the temperature port, and temperature icon 3330 indicates whether the temperature probe is connected to the temperature port. Further, the measurement instrument can communicate to a label printer for printing test results, a computer, and a thermal bath. As such, the status bar 3300 can additional display a printer icon 3330, a computer icon 3340, and a bath icon 3350 to indicate that whether a printer, a computer, or a thermal bath has been connected to the measurement instrument.

The measurement instrument uses a touch screen display. Navigation of the instrument features is done using a variety of Data Fields, Arrows, Command Keys and Navigation Icons. The operating system is designed for intuitive operation and employs color to assist the user in identifying Options.

Data Fields (see FIGS. 28 and 29) require that the user touch the screen to initiate the data entry/selection process. These fields are normally outlined in black. They may also include an arrow 2810 (e.g., blue). Arrows indicate that options exist for a Data Field. The User may be required to press anywhere within the Data Field box or they may have to press the Arrow specifically.

Command Keys 2950 are buttons which direct the measurement instrument to perform a specific action, such as SAVE a data set or STOP a program. Command Keys may be presented in a variety of colors. These keys are normally found at the bottom of the screen.

Navigation Icons 2820 and 2830 are normally found in the Title Bar to the left and right. These icons/buttons can take a user to specific areas of the operating system.

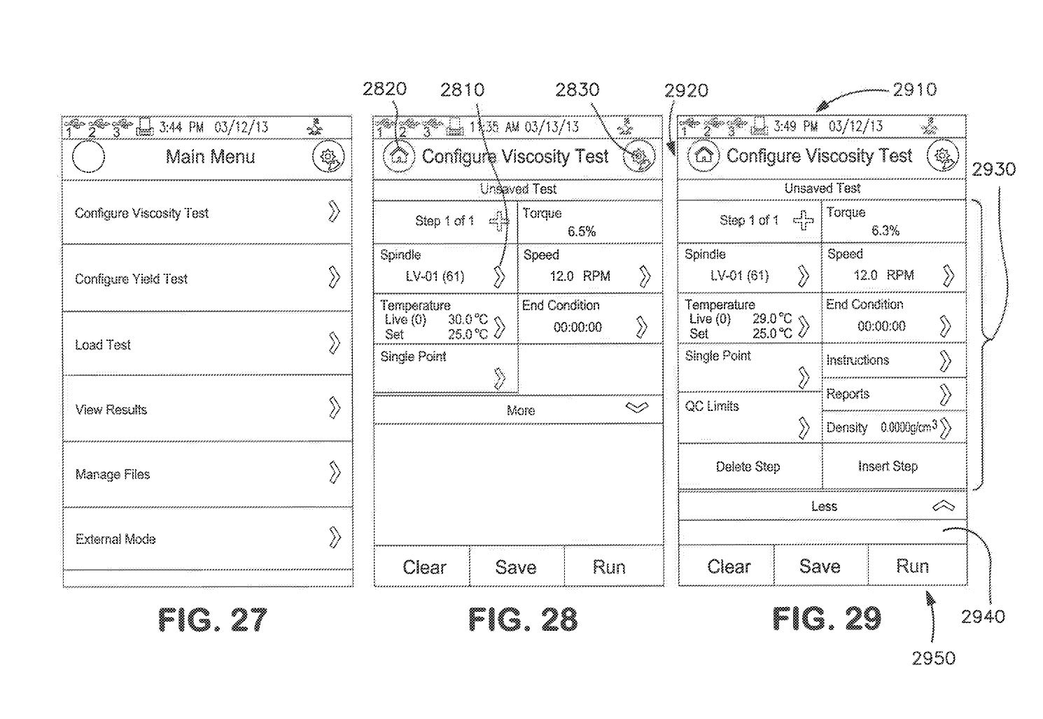

The Home screen (FIG. 27) can be accessed by using the Home Icon 2820. The Home screen shows the Main Menu functions and provides access to the User Log in screen and the Settings screen. The Main Menu functions include the following:

CONFIGURE VISCOSITY TEST: Create and Run viscosity tests.

Viscosity measurements are made through the Configure Viscosity Test function. In one case, the user is presented with Configure Viscosity Test at the conclusion of the Auto Zero function on power up or by selection on the Home Menu. All elements related to the measurement of viscosity may be selected within the Configure Viscosity Test screen (FIGS. 28 and 29). Tests that are created can be saved to the internal memory of measurement instrument or onto a connected memory stick. Tests can be loaded from memory by selecting Load Test from the Home Screen. Many aspects of Configure Viscosity Test can be restricted by user if User ID and Log In functions are implemented (see FIGS. 10 and 11). The basic Configure Viscosity Test view is shown in FIG. 28. This view includes the Status Bar, Title Bar (which includes the Home and Settings icons), data path information, test parameters, the More/Less bar, and Command Keys.

The Data Path is shown in the gray bar just below the Title Bar. The user can see in this area the selected path location that is utilized if Save is selected from the Command Keys. The user can also see the name of any test that has been loaded through the Load Test function. For example, the path can be shown as Internal Memory and the file name is listed as Unsaved Test indicating that the current test has not been saved.

The More/Less bar is seen just below the test parameters. In FIG. 28, this bar includes a down arrow which indicates that more information is available. FIG. 29 shows the additional information that can be accessed. The More/Less bar now has an up arrow indicating that the additional information can be hidden.

The Command Keys include Clear, Save, and Run. Pressing the Clear key clears all data that has been entered into the test parameters and restore the values to the factory default. Pressing the Save key saves the current Test. Pressing the Run key runs the current Test. The Test Parameter area includes many elements of the viscosity test as well as live measurements of Torque % and Temperature. Temperature data is only displayed if a temperature probe is connected to the measurement instrument.

Referring to FIGS. 28 and 29, Torque field shows a live signal from the measurement instrument; Spindle field shows the currently selected spindle (all viscosity, shear rate, and shear stress calculations are made based on this spindle, and the spindle number may be changed by pressing the blue arrow); Speed field shows the currently selected speed of rotation (the measurement instrument operates at this sped once the RUN command key is pressed, and the speed may be changed by pressing the blue arrow); Temperature field shows a live signal from the measurement instrument when a temperature probe is attached; End Condition field specifies the condition that will end the test; Data Collection field specifies the amount of data to be collected during the test; Instructions field creates a message that the user will see when the test begins; Reports field defines how the data will be viewed when the test is complete; QC Limits field defines the limits for acceptable measurement data; and Density field defines the density of the test sample (this information is used when kinematic viscosity units are selected for display).

LOAD TEST: Load a test that has previously been saved or created with a software. Tests may be loaded from internal memory or a memory stick.

Test programs that are created (Configure Viscosity Test) can he saved to the internal memory of measurement instrument or to a memory stick. These files can be reloaded into the measurement instrument for immediate use through the Load Test function. A file that is placed onto a memory stick can he loaded onto the measurement instrument.

Within the Load Test function, the user can access the internal memory of the viscometer or any memory stick that is connected to a USE port. The measurement instrument points to the memory stick according to the order in which the memory stick is connected. The first memory stick that is connected is referred to as #1 on both the Load Test screens and the Status Bar. In this example, one can have as many as three memory sticks connected to the measurement instrument at any time.

Test files that are displayed on the screen can be sorted by date of creation or by an alphanumeric order. This sorting can be selected by pressing a Navigation Icon. One can use the Manage Files function to move Results files from internal memory to a memory stick.

VIEW RESULTS: Load test results that have previously been saved. Results may be loaded from internal memory or a memory stick.

Test results (data files) can be saved to the internal memory of the measurement instrument or to a memory stick. Theses files can be reloaded into the measurement instrument for review, analysis, or printing through the View Results function. A file of Test Results that is saved onto a memory stick can be viewed on any measurement instrument.

Within the View Results function, the user can access the internal memory of the measurement instrument or any memory stick that is connected to a USB port. The measurement instrument points to the memory stick according to the order in which the memory stick is connected. The first memory stick that is connected is referred to as 41 on both the View Results screen and the Status Bar. In this example, one can have as many as three memory stick connected to the DV2T at any time. Results files that are displayed on the screen can be sorted by date of creation or by an alphanumeric order. This sorting can be selected by pressing a Navigation Icon. One can use the Manage Files function to move Results files from internal memory to a memory stick.

MANAGE FILES: Manage the file system in the internal memory or on a memory stick for test programs and saved data. Create new folder structures, delete files, rename files and move files.

Results Files and Test Files can be managed in the internal memory or on memory sticks from the Manage Files function. Folder structures can be added or changed to assist with data management. Files may be copied, moved, renamed or deleted. Access to this function can be limited when User ID and Log in functions are implemented, see FIGS. 10 and 11. Files that are displayed on the screen can be sorted by date of creation or by an alphanumeric order. This sorting can be selected by pressing the Navigation Icon.

EXTERNAL MODE: Direct the measurement instrument to communicate with a software (e.g., Brookfield's RheoCalc software) for complete viscometer control.

The measurement instrument can be controlled from a computer through the use of an optional software program (e.g., Brookfield's Rheocalc software) executed on the computer. The measurement instrument should be placed into external control mode from the Main Menu. The measurement instrument should be connected to the computer with a USB cable. The Status Bar will indicate a proper connection to the computer by displaying the Computer Icon. In this mode, the measurement instrument displays External Mode when configured for operation with the computer. This display includes a Return button that resets the measurement instrument to a stand alone operation.

The measurement instrument calculates the measurement range for a specific spindle and speed combination. This information can be displayed on the screen while selecting the spindle number. The Range information can also be shown in the Running Viscosity Test view during the measurement (see, for example, FIGS. 7 and 8). Viscosity can be displayed in the unit of measure specified in the Settings and is set to centipoise (cP) from the factory.

The measurement instrument can provide indications on the screen when the measurement is out of range of the instrument. When the % Torque reading exceeds 100% (over range), the display of % Torque, Viscosity, and Shear Stress may be “EEEE” and the like. When the % Torque is below zero (negative values), the display of Viscosity and Shear Stress may be “- - - -” and the like.

Measurement data should not be collected when the % Torque reading is out of range. The out of range condition can he resolve by either changing the speed (reduce speed when reading is out of range: high) or changing the spindle (increase the spindle size when the reading is out of range: low). When comparing data, the test method is critical. it is important to know the proper spindle and speed required for the test method. If readings are out of range, this condition should be reported as the test result.

The measurement instrument can communicate to a label printer. The label printer is commercially available from Brookfield Engineering Laboratories Inc, of Middleboro, Mass. The communication to the label printer may be via a USB cable. When the label printer is connected to the measurement instrument, the printer icon 3330 will become visible in the status bar (see FIG. 33). The measurement instrument can configure the print out for several formats of paper/labels. These various paper/label stocks are Also commercially available from Brookfield Engineering Laboratories Inc. of Middleboro, Mass.

For the purpose of better describing and defining the present disclosure, it is noted that terms of degree (e.g., “substantially,” “about,” and the like) may be used in the specification and/or in the Claims. Such terms of degree are utilized herein to represent the inherent degree of uncertainty that may be attributed to any quantitative comparison, value, measurement, and/or other representation. The terms of degree may also be utilized herein to represent the degree by which a quantitative representation may vary (e.g., ±10%) from a stated reference without resulting in a change in the basic function of the subject matter at issue.

Although the measurement instrument of the present disclosure are directed to a viscometer or a rheometer, it is to be understood that various features of the present disclosure can be applicable to other types of measurement instruments. Further, it will be obvious to those recently skilled in the art that modifications to the apparatus and process disclosed herein may occur, including substitution of various component parts or nodes of connection, without departing from the true spirit and scope of the present disclosure.

What is claimed is:

1. An apparatus for measuring viscosity of a liquid, comprising:
a console unit having a touch screen at a front portion thereof, the touch screen displaying a graphical user interface configured to receive input and display output for a viscosity measurement;
a driving member coupled to the console unit and configured to rotate a spindle in the liquid;
a deflection member coupled to the console unit and configured to measure viscous drag of the liquid against the rotating spindle; and
a base stand supporting the console unit.

2. The apparatus of claim 1, wherein the console unit further comprises a leveling indicator disposed at the front portion of the console unit adjacent a lower edge of the touch screen.

3. The apparatus of claim 2, wherein the base stand comprises leveling feet to control leveling of the console unit in view of the leveling indicator.

4. The apparatus of claim 3, wherein the touch screen is slanted at an angle relative to a vertical direction.

5. The apparatus of claim 4, wherein the angle is about 15 degrees.

6. The apparatus of claim 1, further comprising a height adjustment mechanism coupled between the console unit and the base stand.

7. The apparatus of claim 1, wherein the graphical user interface comprises a graphical representation of viscosity data measured real time from the deflection member.

8. The apparatus of claim 1, wherein the graphical user interface comprises an alphanumeric representation of one or more test result data of the viscosity measurement.

9. The apparatus of claim 8, wherein said one or more test result data comprises one or more of a viscosity value, a shear stress value, a temperature value, a torque value, a shear rate value, and a rotation speed value.

10. The apparatus of claim 1, wherein the graphical user interface comprises an alphanumeric representation of one or more test parameters of the viscosity measurement.

11. The apparatus of claim 10, wherein said one or more test parameters comprise one or more of a spindle type, a temperature setting, a data collection method, a rotational speed setting, and an end condition.

12. The apparatus of claim 1, wherein the graphical user interface comprises a status bar at a top portion of the touch screen, the status bar displaying one or more of a USB icon, a printer icon, a computer icon, a thermal bath icon, a temperature icon, and date/time information.

13. The apparatus of claim 1, wherein the graphical user interface comprises a command bar at a bottom portion of the touch screen, the command bar displaying one or more of a clear button, a save button, and a run button.

14. A method for measuring viscosity of a liquid, comprising:
configuring viscosity test parameters through a graphical user interface displayed on a touch screen of a measurement instrument;
providing the viscosity test parameters to a driving member of the measurement instrument to drive a spindle in a sample liquid in accordance with the viscosity test parameters;
measuring viscous drag of the sample liquid against the rotating spindle; and
displaying on the touch screen a graphical representation of measurement results associated with the viscous drag.

15. The method of claim 14, further comprising loading the viscosity test parameters from a data file saved in a memory of the measurement instrument.

16. The method of claim 14, further comprising loading the viscosity test parameters from a data file saved in a memory device coupled to a communication port of the measurement instrument.

17. The method of claim 14, further comprising, prior to configuring the viscosity test parameters, entering a user identification through the graphical user interface to restrict access of the measurement instrument.

18. The method of claim 14, further comprising auto-zeroing the measurement instrument to set zero readings of the measurement instrument.

19. The method of claim 14, further comprising leveling the measurement instrument by referencing a leveling indicator disposed adjacent a lower edge of the touch screen.

20. The method of claim 14, further comprising displaying on the touch screen an average value of the measurement results.

21. The method of claim 14, further comprising loading the viscosity test parameters from a test result data file including test parameters and test result data of a previously performed measurement, so as to perform the viscosity measurement under the same test parameters of the previously performed measurement.

22. A computer program product stored in a memory of a measurement instrument, the computer program product, when executed by a processor of the measurement instrument, causing the measurement instrument to perform a method for measuring viscosity of a liquid, the method comprising:
configuring viscosity test parameters through a graphical user interface displayed on a touch screen of the measurement instrument;
providing the viscosity test parameters to a driving member of the measurement instrument to drive a spindle in a sample liquid in accordance with the viscosity test parameters;
measuring viscous drag of the sample liquid against the rotating spindle; and
displaying on the touch screen a graphical representation of measurement results associated with the viscous drag.
